(19) United States
(12) Patent Application Publication
(10) Pub. No.: US 2009/0138280 A1
(43) Pub. Date: May 28, 2009

(54) MULTI-STEPPED DEFAULT DISPLAY PROTOCOLS

(75) Inventors: Mark Morita, Arlington Heights, IL (US); Prakash Mahesh, Hoffman Estates, IL (US); Murali Kumaran Kariathungal, Hoffman Estates, IL (US)

Correspondence Address: Andrus, Sceales, Starke & Sawall, LLP, 100 East Wisconsin Avenue, Suite 1100, Milwaukee, WI, 53202-4178, US

(73) Assignee: The General Electric Company, Schenectady, NY (US)

(21) Appl. No.: 11/945,049

(22) Filed: Nov. 26, 2007

(51) Int. Cl. G06Q 50/00

(52) U.S. Cl. 705/3

(57) ABSTRACT

A multi-stepped default display protocol for diagnostic image review may be implemented using a computer readable medium coupled to a computer which is in turn coupled to a graphical display. The multi-stepped default display protocol may be stored on the computer readable medium from which the computer may read the multi-stepped default display protocol and display diagnostic images on the graphical display in accordance. The graphical display may present the diagnostic images according to the multi-stepped default display protocol by projecting a first display of medical information, providing an indication of at least one alternative display of medical information, receiving a selection of alternative medical information, and projecting the selected alternative display medical information.

### FIELD OF THE DISCLOSURE

The present disclosure relates to the field of information processing and presentation. More specifically, the disclosure relates to the creation and implementation of protocols for the display of medical information.

### BACKGROUND

Diagnostic imaging includes images of specific anatomical locations or regions acquired from modalities such as X-ray, computed tomography (CT), or magnetic resonance imaging (MRI) of specific anatomical locations or regions. A radiologist or other clinician then views and interprets the diagnostic images and provides annotations and analysis regarding any regions of interest identified in the images. The diagnostic images may then be forwarded to a physician or other clinician for review of the images and annotations, resulting in a diagnosis of the medical condition of the patient.

One specific field of diagnostic imaging is that of mammography. Mammography is an exemplary field of diagnostic imaging due to the challenges of image acquisition, interpretation, and analysis. Therefore, while the disclosure herein is done so with respect to mammography, it is understood that a full range of diagnostic imaging fields may be improved by the GUI, system, and method as disclosed herein.

With the advent of digital diagnostic imaging, great efficiencies have been made in terms of reduced physical storage needs and image interpretation times. The use of digital imagery not only eliminates the need for the archival and storage of the physical diagnostic images, but also allows the radiologist or other clinicians the ability to recall diagnostic images from any computer terminal or device that is communitively connected to a hospital PACS system or information network on which the digital diagnostic images are stored.

However, the systems and methods presently available for viewing the diagnostic images are limited in ways that cost clinicians valuable time in selecting, acquiring, and arranging the diagnostic images so that the images can be viewed and interpreted. Present systems and methods for displaying diagnostic images may utilize default display protocols (DDP) that define an initial view or angle of diagnostic image that is presented to the clinician. Alternative DDPs may prompt a display with a listing, or thumbnail images of the alternative available diagnostic images for the clinician's review.

These systems are limited because a clinician must typically review multiple diagnostic images in formulating an interpretation or diagnosis. Under presently available systems and methods, the clinician must select each alternative image from a listing of available images or thumbnail images. Once the new image has been selected, the clinician must configure the display for each of the images. This may include selecting the resolution, aspect ratio, or zoom of the selected image.

Additionally, a clinician may desire access to other forms of patient data to give context to or provide additional information for interpreting the diagnostic images. In these situations the clinician may have to close or minimize the current diagnostic image while opening a new file or program that includes the desired patient data. This further presents an inefficient system for the viewing and interpretation of the diagnostic images.

Some systems for viewing diagnostic images allow for the establishment of one or more DDPs that may include stored image characteristics or configurations for specific types of diagnostic images. Other available systems, such as the centricity RA1000 Workstation available from GE Healthcare provide the clinician with the ability to string DDP's together to form a simple multi-stepped DDP that configures the display of multiple images from a single study.

However, under the presently available systems and methods, the clinician must still expend valuable time selecting and configuring images of a routine diagnostic image examination or navigating to open desired patient data.

### BRIEF DISCLOSURE

Diagnostic images from multiple imaging modalities and/or other patient data may be displayed according to a multi-stepped default display protocol. The multi-stepped DDP may define display protocols for each of a plurality of diagnostic images from one or more imaging modalities. The multi-stepped DDP may also define the concurrent display of other patient medical data. The diagnostic images and patient data may be presented in an order that is defined in the multi-stepped DDP. A system is disclosed herein for the implementation, creation, and use of multi-stepped DDPs. The system may include a display for displaying both diagnostic images and patient data, a computer operable to control the display of diagnostic images and patient data on the display and a computer readable medium configured with multi-stepped DDPs, such that the computer controls the display of diagnostic images and patient data according to the multi-stepped DDPs.

Also disclosed herein is a graphical user interface (GUI) for the display of graphical information. The GUI may include a first data display region displaying a first configuration of medical information and a second data display region displaying a second configuration of medical information. A display configuration indicator indicates a plurality of alternative configurations of the first and second display regions. The graphical user interface may further include a display configuration selector that receives a selection of the next configuration of the first and second display regions from between the plurality of alternative configurations. The graphical user interface may further include that each of the alternative configurations of the display region displays different medical information as is defined according to a multi-stepped DDP.

Further disclosed herein is a method of using and creating a multi-stepped DDP. Embodiments of the method may include the steps of simultaneously projecting first and second displays of medical information according to a multi-stepped DDP, providing an indication of alternative display configurations, receiving a selection of an alternative display configuration and projecting first and second displays of medical information according to the selected display configuration. Alternative embodiments of the method may further include receiving a definition of a first medical information display, receiving a definition of a second medical information display, saving received definitions as a display configuration and saving the display configuration to a multi-stepped DDP.

### BRIEF DESCRIPTION OF THE DRAWINGS

FIG. 1 depicts an embodiment of a computer workstation for use with a multi-stepped default display protocol;

FIG. 2 depicts an embodiment of a graphical user interface for use with a multi-stepped default display protocol;

FIGS. 3a-3f depict exemplary first and second data display regions in accordance with embodiments of display configurations of a multi-stepped default display protocol;

FIG. 4 graphically represents an embodiment of a multi-stepped default display protocol;

FIG. 5 is a flow chart with the steps of an embodiment of using a multi-stepped default display protocol; and

FIG. 6 is a flow chart with the steps of an embodiment of a method of creating a multi-stepped default display protocol; and

### DETAILED DISCLOSURE

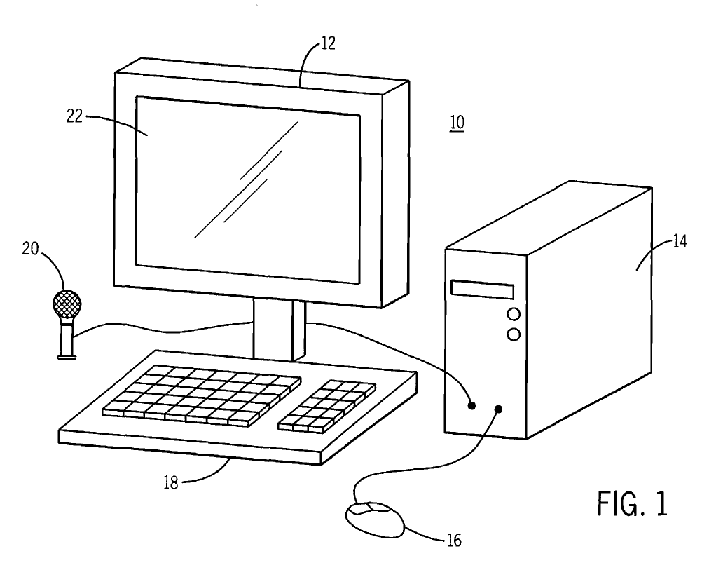

FIG. 1 depicts a computer workstation which may be used in implementing embodiments of a multi-stepped default display protocol (DDP) as disclosed herein. The computer workstation 10 includes a monitor 12 which is connected to a computer 14. The computer 14 includes memory (not depicted) and a processor (not depicted) that serve the respective functions of storing information and the control and manipulation of the information. The memory may include a computer readable medium that may be configured to store one or more multi-stepped DDPs. The computer 14 may further be connected to a hospital information network or PACS system (not depicted) that includes other computer workstations and data storage such as servers that enable centralized data storage of patient records and diagnostic images while promoting access to the medical information from a variety of locations. Additionally, the hospital information network or PACS system (not depicted) may further include wireless communication and/or internet access such that the computer workstation 10 may be located at a remote location from the hospital building. The computer workstation 10 may alternatively include other types of workstations such as a personal digital assistant, a notebook computer, or other types of integrated hand-held computers.

The computer workstation 10 may further include a variety of user input devices. These input devices may include a mouse 16, a keyboard 18, or voice activated controls utilizing a microphone 20. Additionally, the monitor 12 includes a display 22. The display 22 presents information to the user. The display 22 may facilitate the display of information and the receipt of information through the aforementioned user inputs by the use of a graphical user interface (GUI). Additionally, the display 22 may be incorporated with touch screen technology such that the display 22 also performs the function of a user input device.

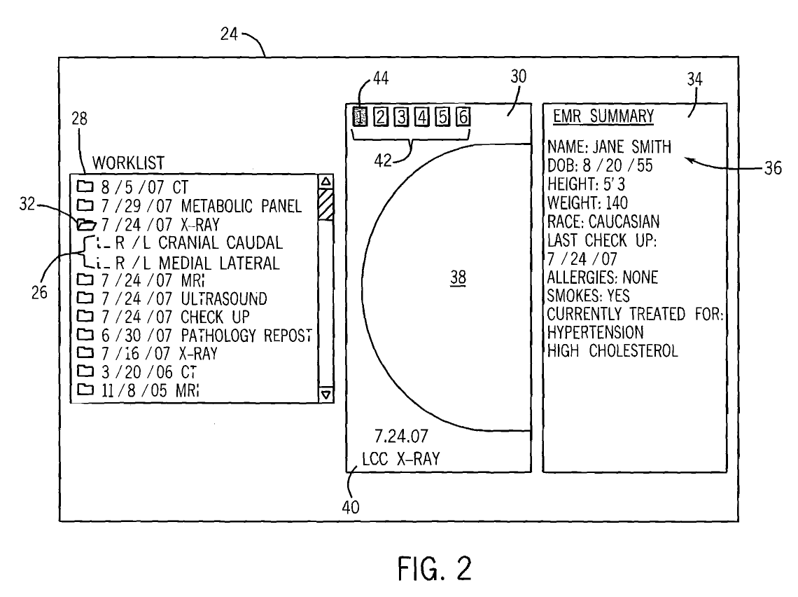

FIG. 2 depicts a graphical user interface 24 as may be displayed on the display 22 of FIG. 1. The GUI 24 may comprise a variety of regions that perform different display and/or input functions. The GUI 24 may comprise a worklist 28 that displays a listing of the available medical information that may be displayed on the graphical user interface 24. The worklist 28 may be subdivided into folders identifying specific procedures by procedure and the date upon which it was performed or reported. Exemplary imaging procedure modalities that may be included on the worklist 28 include X-ray, Computed Tomography (CT), magnetic resonance imaging (MRT), or ultrasound; however, these modalities are not intended to be limiting on the scope of diagnostic images that may be utilized in accordance with the system and methods as disclosed herein as others including position emission tomography (PET) and nuclear medicine imaging (NMI) may be used.

Each folder for a specific procedure may be opened to view one or more files associated with that medical procedure. As an example, the Jul. 24, 2007 X-ray procedure folder 32 is depicted as being opened and a plurality of X-ray diagnostic image files 26 acquired during that procedure are displayed in the worklist 28.

In addition to the diagnostic imaging procedures displayed in the worklist 28, the worklist 28 may also include patient data from other procedures such as patient check up data, laboratory test results, and pathology reports. However, this is not intended to be limiting on the scope of patient data that may be used in connection with the multi-stepped DDP's as disclosed herein as the patient data may also include demographics, problem lists, allergies, current medication, historical patient data, a patient electronic medical record (EMR), recently acquired patient vitals, or other clinical or patient data. It is further understood that the worklist 28 may be organized to present data in a variety of ways and is not herein limited to the folders and sub-folders as disclosed. For example, alternative embodiments may present the worklist as a drop down menu or a separate window.

The GUI 24 includes a first data display region 30. The first data display region 30 displays diagnostic images or patient data according to a display configuration of a multi-stepped DDP. The GUI 24 further includes a second data display region 34 that also display a diagnostic images or patient data according to the display configuration of the multi-stepped DDP. As depicted in FIG. 2, the first data display region 30 displays a diagnostic image 38, that of a left cranial caudal (LCC) mammography X-ray image. The second data display region 34 displays patient data 36 as represented by an EMR summary.

The first 30 and second 34 data display regions may be the main focal point of the GUI 24 as the clinician may use the combination of displayed diagnostic images and/or patient data to facilitate the interpretation annotation, and resulting diagnosis from the diagnostic images and patient data. Each diagnostic image 38 may further include an image identifier 40 associated with the image that provides identifying information. The image identifier 40 may include information relating to the date upon which the image was acquired and/or a written description of the image. The image identifier 40 associated with the LCC diagnostic image 38 identifies that the image was acquired on Jul. 24, 2007 and that the image displays the left cranial caudal (LCC) view taken by the X-Ray imaging modality.

The display of a diagnostic image 38 in the first data display region 30 and the display of patient data 36 in the second data display region 34 is desirable at times as the clinician interpretation and diagnosis based on the diagnostic image 38 may be improved with the increased medical context provided by the patient data 36. The improved medical context associated with the presentation of patient data along with the diagnostic image being investigated may improve the quality of a clinician's review of the diagnostic image by pointing out or highlighting particular aspects of the patient's medical history that may be helpful or instructive to the clinician in interpreting the diagnostic image. As an example, during the clinician review of the diagnostic image 38 the clinician may reference the patient data 36 to see that the patient is a Caucasian in her 50s with high cholesterol and is a smoker. These indications may place her at an increased risk for cancer or other disease and therefore, the clinician may view her X-ray diagnostic image 38 with increased scrutiny commensurate with this increased risk. Additional examples of such improvement of diagnostic imaging display and interpretation efficiency will be discussed further herein.

Additionally, the first data display region 30 may further include a display configuration indictor 42; however, the display configuration indicator 42 need not be included with the first data display region 30 but rather may be located anywhere on the GUI 24. The display configuration indicator 42 may identify the number of images in the multi-step DDP. Alternatively the display configuration indicator may provide a thumbnail version of the configuration or other symbolic general representation or identification of the configuration. In one embodiment this identification is a symbolic representation of the number of data display regions. In another embodiment the indication is an alpha-numeric indication of one or more diagnostic image modalities represented in the configuration. The display configuration indicator 42 may further include an indication 44 of the currently active display configuration of the multi-stepped DDP. This is indicated by the darkened “1” indication 44.

The display configuration indicator may additionally perform the function of being a button and/or “widget” that facilitates a user selection to cycle through to the next display configuration as according to the multi-stepped DDP. Alternatively, this function may be performed by a separate button (not depicted) on the graphical user interface 24, or may be implemented using an input that is not otherwise associated with controlling the visual display on the graphical user interface 24, such as a voice command into a microphone controller 20 or the activation of a particular key on the keyboard 18 (both depicted in FIG. 1). Alternatively, the clinician may be able to select any of the display configurations on the display configuration indicator 42 to navigate outside of the default predetermined image and data cycle.

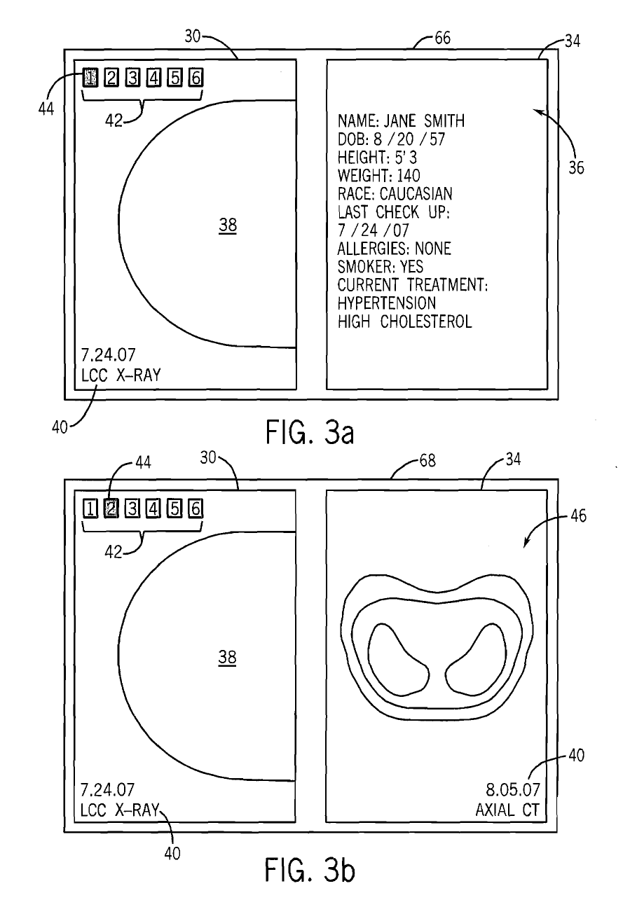

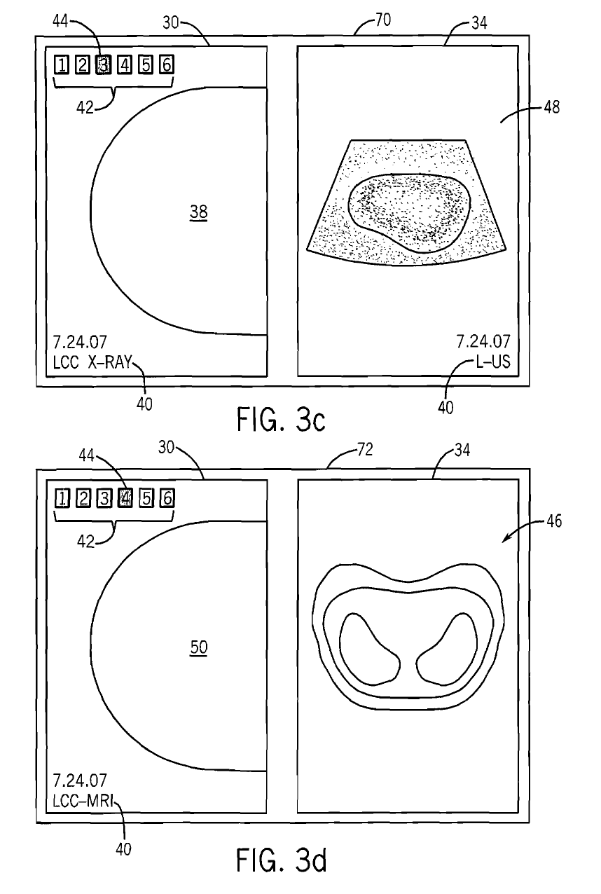

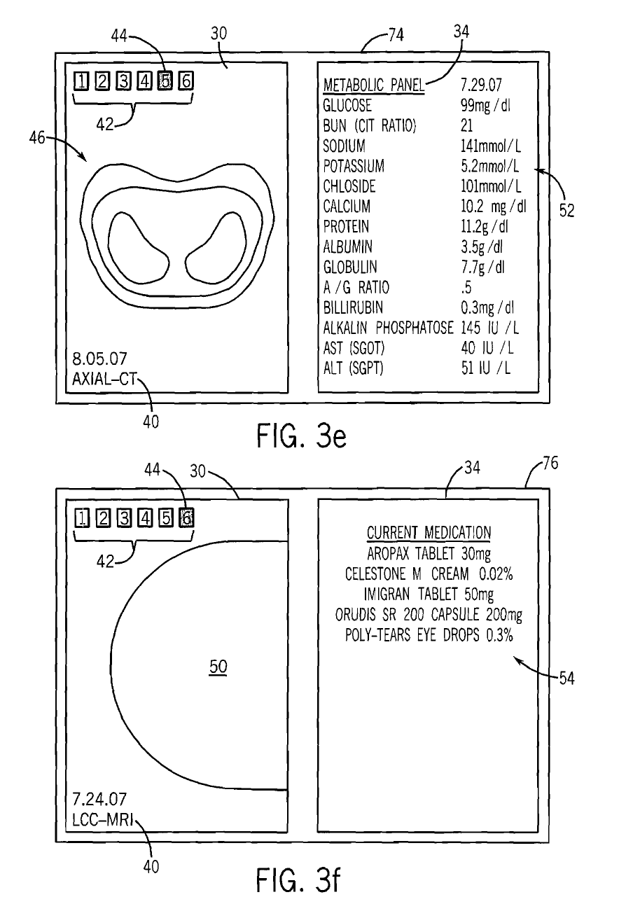

As disclosed in further detail herein, the multi-stepped DDP includes a plurality of display configurations, each defining a combination of the display of diagnostic images and/or patient data that is arranged in a predetermined order. The multi-stepped DDP may be defined by the preferences of the clinician, medical institution, and/or medical device/software providers. FIGS. 3a-3f, depict various examples of display configurations that may be part of the plurality of display configurations of the multi-stepped DDP.

The multi-stepped DDP herein disclosed improves upon previous systems and methods that require clinicians to individually modify the display configuration for viewing diagnostic images and then separately navigate patient data records. the presently disclosed multi-stepped DDP combines what previously had been individual and disconnected preference settings or user interfaces into a single protocol that not only defines the images to be viewed, but defines the order in which the images are viewed and any image processing that is required to correctly format the images for display according to the protocol. The multi-stepped DDP may be created to display images and patient data in a specified order, such as a clinician's, a hospital's, or a healthcare provider's preferred order of review of diagnostic images for formulating a diagnosis.

FIG. 3a depicts a first display configuration 66 that is the same as the display configuration depicted in FIG. 2. The display configuration indicator 42 indicates with the image indicator 44 that this is the first display configuration as part of a six display configuration multi-stepped DDP. The first display configuration 66 presents a diagnostic image 38 in the first data display region 30 and patient data 36 in the second data display region 34. It is understood that the orientation of the first and second display regions (30, 34) and the diagnostic image 38 and patient data 36 may be modified in any of a number of ways, such as those that may be dictated by the preferences of a clinician, hospital, or healthcare provider. As stated above, the first display configuration 66 may be a desirable configuration due to the fact that patient medical history context is provided to the clinician when viewing the diagnostic image 38. The medical history context may affect the clinician's review and interpretation strategy of the diagnostic image 38 wherein the clinician may spend additional time searching for a particular abnormality while spending less time looking for others abnormalities that the patient's medical history may indicate are of less risk or concern.

FIGS. 3b-3d each depict display configurations that represent various combinations of diagnostic images presented in both the first data display region 30 and the second data display region 34. These figures are provided to depict an embodiment of a display configuration of a multi-stepped DDP wherein the clinician is presented two or more diagnostic images to facilitate the review and interpretation of both of the images. In each of these examples, the diagnostic images in the first data region 30 and the second data region 34 are of two different diagnostic imaging modalities. The presentation of the same anatomical region, but acquired by different modalities further facilitates the clinician's ability to interpret a diagnostic image and diagnose the patient's condition. The comparison of two diagnostic images acquired by different imaging modalities may allow the clinician to rely upon the strengths of each of the imaging modality, while ensuring a medical condition is not missed due to the limitations of an image acquired by one particular modality. Alternatively, the comparison of diagnostic images acquired by two different imaging modalities facilitates the identification of imaging artifacts, which may result in a false positive diagnosis. Many image artifacts are due to inherent characteristics of the imaging technique and thus are specific only to that particular imaging modality. Therefore, a clinician viewing a region of interest in a diagnostic image of a first modality that does not appear in a similar diagnostic image acquired by a different modality, may use this information to identify that the region of interest is in fact an imaging artifact.

Referring now to FIG. 3b, a second display configuration 68 is depicted. The second display configuration 68 presents the same left cranial caudal (LCC) x-ray diagnostic image 38 in the first data display region 30 as is depicted in FIG. 3a. However, in the second data display region 34 an axial CT diagnostic image 46. The axial CT diagnostic image 46 is identified as such by the image identifier 40. CT is an imaging modality that produces images that are slices through a target anatomical region of the patient. In the axial CT diagnostic image 46, the CT slice is through the chest of the patient, whereby the clinician may then compare the slice through the chest of the patient in the second data display region versus the cranial caudal x-ray image of the patient's left breast that is depicted in the diagnostic image 38 presented in the data display region 30.

FIG. 3c depicts a third display configuration 70. The display configuration 70 replaces the CT diagnostic image 46 of FIG. 3b with an ultrasound image 48 displayed by the second data display region 34. The third display configuration 70 depicts that diagnostic images of different modalities may both be presented in the first data display region 30 and the second data display region 34 and that this may include multiple imaging modalities that may be interchanged depending upon the need and/or requirements as defined in the display configuration of the multi-stepped DDP.

Finally, FIG. 3d depicts a fourth display configuration 72. The fourth display configuration 72 exemplifies the concept that the first data display region need not display an X-ray diagnostic image, but rather may display a diagnostic image acquired using a different imaging modality, such as an MRI diagnostic image 50. In the fourth display configuration 72 an MRI diagnostic image 50 may be compared to the CT diagnostic image 46 to aid the clinician's review of the diagnostic images.

FIGS. 3e and 3f depict still further embodiments of the possible display configurations that may be a part of the plurality of display configurations of a multi-stepped DDP. FIG. 3e depicts a fifth display configuration 74 that displays a CT diagnostic image 46 in the first data display region 30 and metabolic panel lab results 52 in the second data display region 34. The fifth display configuration 74 depicts an instance when a clinician, hospital, or healthcare provider deems it valuable to provide additional medical context with respect to the patient's medical condition to facilitate the clinician's interpretation of the diagnostic image 46. The patient's metabolic panel 52 may provide additional information regarding the function of the patient's body that provides further insight into the interpretation of the CT diagnostic image 46 that the clinician may not have had if viewing the CT diagnostic image 46 alone.

FIG. 3f depicts a similar embodiment wherein a sixth display configuration 76 displays an MRI diagnostic image 50 in the first data display region 30 and a list of patient current medication 54 in the second data display region 34. As with the fifth display configuration 74, the clinician viewing the MRI diagnostic image 50 may gain any further insight in the interpretation from knowing the current medications that the patient is using as identified by the patient medication list 54.

While the display configurations in FIGS. 3a-3f depict various embodiments of the display configurations that may be established within of a multi-step DDP, these display configurations are merely exemplary of the types of configurations that may be defined within the multi-stepped DDP. Various alternatives and embodiments in connection with the spirit of the present disclosure are considered to be within the scope of the presently disclosed system and method.

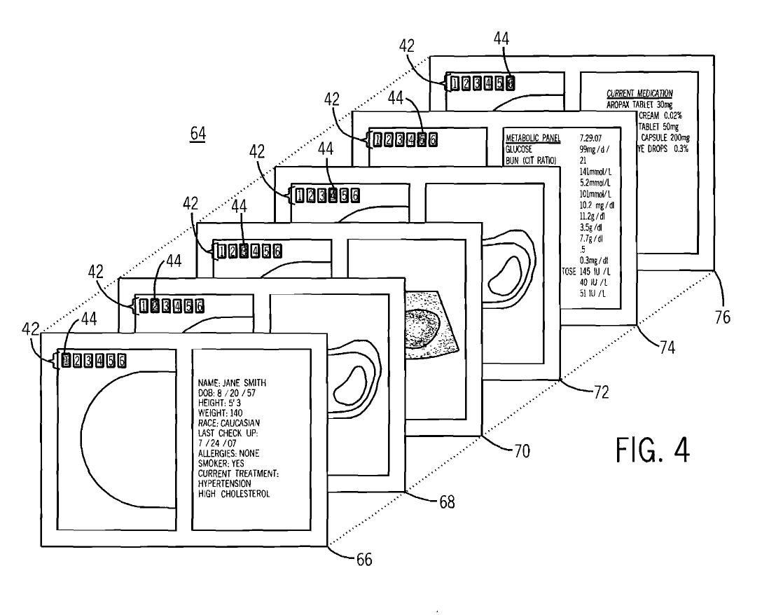

FIG. 4 depicts the multi-stepped DDP as a series of display configurations each configured to provide a different presentation of diagnostic images and/or patient data. While FIG. 4 is merely exemplary of a multi-stepped DDP that includes six display configurations, any number of display configurations may be included in a multi-stepped DDP 64. As stated above, the clinician may cycle through the different display configurations as defined by the multi-stepped DDP 64 by activating a user input of the graphical user interface (FIG. 2) or initiating a command from a user input device (FIG. 1) such as an arrow key, spacebar, mouse click, or a voice command. Otherwise in alternative embodiments, the clinician may select any of the exemplary six display configurations to navigate directly to that display configuration.

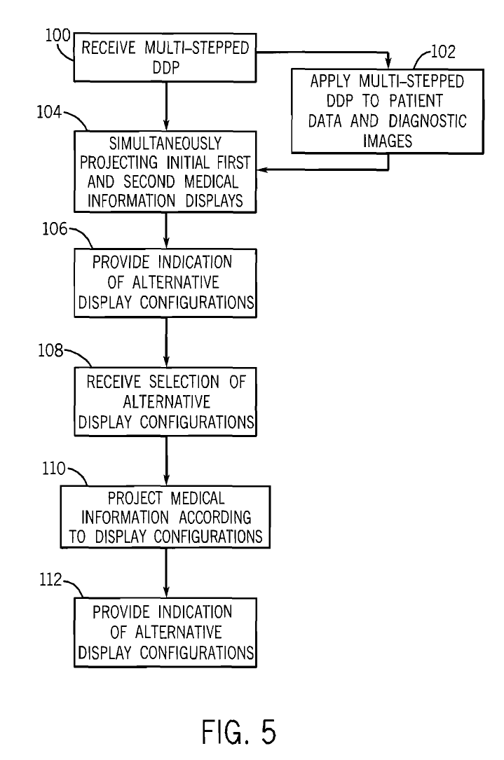

FIG. 5 is a flow chart depicting the steps of an embodiment of a method of utilizing a multi-stepped DDP. Implementation of this embodiment may improve the efficiency of review and interpretation of diagnostic images by a clinician.

First, at step 100, the multi-stepped DDP is received. The multi-stepped DDP may be stored locally at the memory of the computer, or may be stored at one or more centralized servers as part of a hospital or healthcare provider information network. Multiple multi-stepped DDPs may be stored at the data storage location, thereby providing a plurality of multi-stepped DDPs available to the clinician. The multi-stepped DDP implemented may be one that is selected to be used upon initialization of the program, or the multi-stepped DDP may be one that is selected by the particular clinician after initiation of the program. Next, the multi-stepped DDP is applied to the patient data and diagnostic images at step 102. The application of the multi-step DDP in step 102 may further include the selection of the patient or the patient medical history diagnostic images to be used. Then, the multi-stepped DDP is used to simultaneously project initial first and second medical information displays including at least one diagnostic image. The first and second medical information displays may also include a display of patient data. In step 106 an indication of the alternative display configurations in the multi-stepped DDP is provided to the clinician. This step may further include the identification of the display configuration displayed in the initial view along with the indication of the alternative display configurations.

After the clinician has reviewed the medical information display the clinician may make a selection at the next display configuration. At step 108, this selection of an alternative display configuration is received. The selection of an alternative display configuration may include a selection of any available display configurations within the multi-stepped DDP, or may be a selection to cycle to the next display configuration according to the multi-stepped DDP. After the selection has been received in step 108, medical information is projected in step 110 in the first and second data display regions according to the selected display configuration. Next, at step 112 indications of the current display configuration and the alternative display configurations are provided. After the clinician has reviewed the medical information projected in step 110, the method may return to step 108 to receive a new selection of one of the indicated alternative display configurations.

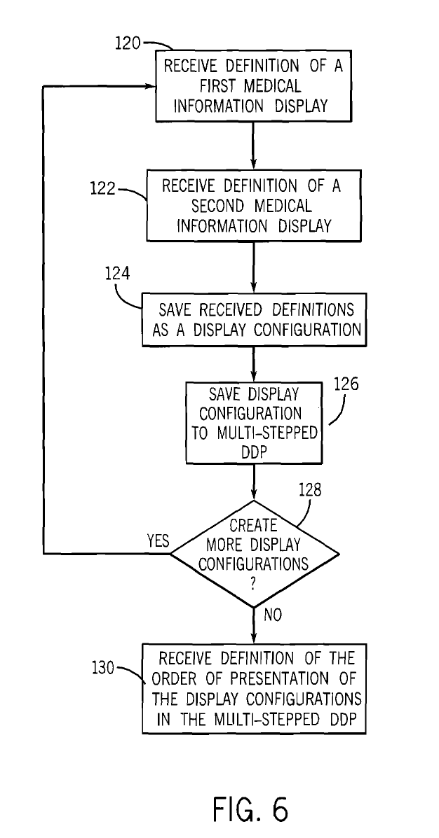

FIG. 6 depicts an embodiment of a method of creating a multi-stepped DDP. In this embodiment, first a definition of a first display is received at step 120. Next, at step 122 a definition of a second medical information display is received. The definitions received in steps 120 and 122 are saved as a display configuration in step 124. The newly created display configuration may be saved as part of a multi-stepped DDP in step 126. The multi-stepped DDP may be saved locally on the computer workstation used by the clinician, or may be stored at a centralized server as a part of a hospital information network.

After the newly created display configuration is saved as one of the plurality of display configurations of the multi-stepped DDP in step 126, it is determined in step 128 whether or not the creation of additional display configuration is desired. If more display configurations are to be created than the method returns to step 120 another new display configuration. If no more display configurations are to be created then a definition of the order of presentation of the display configurations in the multi-stepped DDP is received at step 130. The order may be defined to reflect a recognized order of medical information review for proper interpretation and diagnosis. Alternatively, the order may be defined to reflect a clinician's personal preference of medical information review. The received definition of the order of presentation is then saved to the multi-stepped DDP.

While exemplary embodiments have been described with respect to the systems and methods as disclosed herein, these embodiments are in no way meant to be limiting on the scope of alternative embodiments of the presently disclosed GUI, systems, and methods. Alternative embodiments may include the ability to combine preexisting display configurations into a multi-step DDP by stringing together a series of already defined display configurations and identifying an order in which the configurations are to be presented. An alternative embodiment provides for the ability to edit multi-step DDPs “on the fly” as the clinician may determine during the application of a multi-step DDP that one or more of the configurations of the multi-stepped DDP require editing to the selected images and/or image characteristics in the configuration. Alternatively, the clinician may desire to add and/or drop the display configurations from the saved multi-stepped DDP. Therefore, embodiments of the presently disclosed systems and methods may include the ability to modify the multi-stepped DDPs and save the modified multi-stepped DDPs as new or updated multi-stepped DDPs to be accessed and used later.

The systems and methods as disclosed herein provide advantages over the diagnostic image display systems and methods presently available. The implementation of multi-stepped DDPs can allow for the configuration of diagnostic images and patient data to be displayed in a configuration that maximizes the clinician's ability to review, interpret, annotate and diagnose. The presentation of diagnostic images of different modalities as part of the multi-stepped DDP promotes artifact identification and region of interest comparison. The further presentation of diagnostic images in conjunction with patient data provides the reviewing clinician with an added medical context for viewing the diagnostic images. Information about patient's medical history, lab and pathology results, or current medications may all affect the clinician's review of the diagnostic images or resulting diagnosis.

Additionally, the graphical user interface as disclosed herein allows for the efficient navigation of the multi-stepped DDP as the GUI presents a single navigational platform for accessing diagnostic imagery and patient data.

Finally, multi-stepped DDPs allow for efficient view of diagnostic images by clinicians because the multi-stepped DDP predefines the image selection and image characteristics for proper presentation and configuration within the data display region. The multi-stepped DDPs further conveniently present diagnostic images that are frequently desired by the clinician in diagnosing a patient. This eliminates the need for the clinician to search through diagnostic image files to select the relevant and related diagnostic images and further saves the clinician the time and effort required to modify and/or configure the images to be properly presented on the display.

Embodiments of multi-stepped DDPs may be implemented solely through the use of a computer by commanding the computer to follow computer code or other computer readable instructions. These computer implemented embodiments may produce the technical effect of promoting efficiency of a clinician's review of diagnostic images by decreasing the amount of time that a clinician must spend selecting diagnostic images to view and configuring the selected diagnostic images to fit the diagnostic image display region as well as conveniently presenting the clinician with additional medical information for the purpose of aiding clinician interpretation and diagnosis.

This written description uses examples to disclose features of the embodiments, including the best mode, and also to enable any person skilled in the art to make and use the invention. The patentable scope is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

Various alternatives and embodiments are contemplated as being with in the scope of the following claims, particularly pointing out and distinctly claiming the subject matter regarded as the invention.

What is claimed is:

1. A graphical user interface comprising:
a first data display region displaying a first configuration of medical information, the medical information being selected from a diagnostic image of a first modality and patient data;
a second data display region displaying a second configuration of medical information, the medical information being selected from a diagnostic image of a second modality and patient data;
a display configuration indicator that provides indications of a plurality of alternative configurations of the first and second data display regions;
a display configuration selector that receives a selection of the next configuration of the first and second data display regions from between the plurality of alternative configurations of the graphical information display region;
wherein each of the plurality of alternative configurations differs from each of the other alternative configurations by at least the configuration of the first data display region or the second data display region, the alternative configurations being predefined according to a multi-stepped default display protocol.

2. The graphical user interface of claim 1, wherein the display configuration selector is configured to receive a selection of the next configuration as defined by the multi-stepped default display protocol.

3. The graphical user interface of claim 2, wherein the display configuration indicator displays the indications of the plurality of alternative configurations in a predefined order according to the multi-stepped default display protocol.

4. The graphical user interface of claim 3, wherein the display configuration selector is configured to receive a selection of the next configuration out of any of the plurality of alternative configurations provided by the display configuration indicator.

5. The graphical user interface of claim 1 wherein at least one alternative configuration comprises the first data display region displaying a diagnostic image of a first modality.

6. The graphical user interface of claim 5 wherein the at least one alternative configuration comprises the second data display region displaying a diagnostic image of a second modality.

7. The graphical user interface of claim 5 wherein the at least one alternative configuration comprises the second data display region displaying patient data.

8. The graphical user interface of claim 7 wherein the patient data of the second data display region is correlated to the diagnostic image of the first data display region.

9. The graphical user interface of claim 8, wherein the next configuration of the plurality of alternative configurations defined by the multi-stepped default display protocol maintains the diagnostic image displayed in the first data display region and modifies the patient data displayed in the second data display region.

10. The graphical user interface of claim 9, further comprising at least one additional data display region, the additional data display region displaying an additional configuration of medical information, the medical information being selected from a diagnostic image and patient data.

11. A system for efficiently displaying medical information to a clinician, the system comprising:
a computer readable medium configured with computer executable code defining a multi-stepped default display protocol including a plurality of alternative display configurations, wherein in at least one of the alternative display configurations the first display is a diagnostic image of a first modality and the second display is a diagnostic image of a second modality and wherein in at least one of the alternative display configurations the first display is a diagnostic image and the second display is patient data;
a computer coupled to the computer readable medium such that the computer can execute the code defining the multi-stepped default display protocol and perform operations according to the multi-stepped default display protocol;
a graphical display coupled to the computer, the graphical display having at least a first and a second medical information display region, the graphical display displaying medical information according to the multi-stepped default display protocol.

12. The system of claim 11 wherein the computer readable medium is further configured with computer executable code defining a sequential order in which the plurality of alternative display configurations are presented to a clinician.

13. The system of claim 12 wherein the computer is configured to receive a selection from the clinician wherein the selection prompts the display of the next alternative display configuration according to the defined sequential order.

14. The system of claim 11 wherein the computer readable medium is further configured with computer executable code defining (pick one or two):
at least one of the alternative display configurations further including at least one additional display, the additional display being either a diagnostic image or patient data;
at least one of the alternative display configurations wherein the first and second displays are different modality images of the same anatomical region;
at least one of the alternative display configurations wherein the first display is a diagnostic image and the second display is patient data correlated to the diagnostic image of the first display.

15. A method of displaying medical information using a medical information displaying computer program including a multi-stepped default display protocol including a plurality of display configurations, the method comprising:
simultaneously projecting a first display of medical information and a second display of medical information, the first and second displays being defined by a display configuration of the multi-stepped default display protocol;
providing an indication of a plurality of alternative display configurations of the multi-stepped default display protocol;
receiving a selection of one of the indicated alternative display configurations; and
projecting the first and second display of medical information according to the elected alternative display configuration;
wherein each of the alternative display configurations defines the first display of medical information to be either a diagnostic image or patient data and defines the second display of medical information to be either a diagnostic image or patient data.

16. The method of claim 15 wherein the multi-stepped default display protocol further defines the order of the indication of the plurality of alternative display configurations, the selected alternative display configuration being the next configuration in the defined order.

17. The method of claim 16 further comprising receiving user inputs defining the first and second displays of medical information in at least one alternative display configuration.

18. The method of claim 17 further comprising receiving user inputs defining the order of the indication of the plurality of alternative display configurations.

19. The method of claim 15 wherein at least one alternative display configuration comprises a diagnostic image of a first modality as the first display of medical information and a diagnostic image of a second modality as the second display of medical information.

20. The method of claim 15 wherein at least one alternative display configuration comprises a diagnostic image as the first display of medical information and patient data as the second display of medical information.
